(19) United States
(12) Patent Application Publication
(10) Pub. No.: US 2022/0283002 A1
(43) Pub. Date: Sep. 8, 2022

(54) APPARATUS FOR THE CONTINUOUS REMOTE MEASURING OF THE FLOWRATE OF WATER IN BULKHEAD-HOLDER OPENINGS FOR IRRIGATION

(71) Applicant: Carlo MARELLI, Milano (IT)

(72) Inventor: Carlo MARELLI, Milano (IT)

(21) Appl. No.: 17/597,675

(22) PCT Filed: Aug. 4, 2020
(86) PCT No.: PCT/IB2020/057352

§ 371 Date: Jan. 18, 2022

(30) Foreign Application Priority Data
Aug. 6, 2019 (IT) 102019000014127

(51) Int. Cl. G01F 1/002; G01F 1/661; G01F 1/66

(52) U.S. Cl. CPC G01F 1/002; G01F 1/661; G01F 1/666; E02B 13/02

(57) ABSTRACT

An apparatus for the continuous remote measurement of the flowrate of water in bulkhead-holder openings for irrigation, characterised in that it comprises a measuring instrument installed at a distance relative to a lower crossbeam which acts as a bulkhead in an opening of an irrigation channel; the apparatus comprises vertical uprights integral with the crossbeam and a transmitter device; the apparatus can be installed at an opening of an irrigation channel so that the vertical uprights can be made to slide inside bulkhead-holder grooves provided in the sides of the opening; the apparatus allows the detection of data including at least the level of the surface of the water at the opening and the transmission of said data to a remote location.

### BACKGROUND OF THE INVENTION

This invention relates to an apparatus for the continuous remote measurement of the flowrate of water in bulkhead-holder openings for irrigation.

As is known, the distribution of water for irrigation takes place through channels that draw water from rivers and split into smaller channels called ditches or leads.

Field irrigation management in agriculture is complex and subject to changes in the availability of water due to multiple factors such as: meteorological events, damage/failures/repairs on supply channels/sources, reductions made by supply consortia or other upstream users.

Reliable solutions that are also economically sustainable and that allow the automatic adjustment of the water flow are not widespread to date and therefore the sector relies on a member of staff, the so-called “camparo”, who physically intervenes to modify the flowrate of water through each of the openings and in this way constantly supervise the fields, even several times a day, to check that the water flow rates are constant.

In general, the task of the “camparo” is to check the state of the channels, attending to water leaks, landslides, cleaning of the canal and regulating the flow by taking action on the bulkheads.

Checking of correctness of the flow rates is therefore linked to the presence of the operator.

When this person is absent, the flow rate becomes unknown, resulting in wide margins of uncertainty over correctness of the water flow for the crops; suffice it to think of the nighttime, a period that is normally never supervised.

The problem is particularly felt by the crops that depend most on water, such as rice.

Systems and devices are known for measuring the flowrate of water in closed conduits and open channels.

The simplest, and at the same time most effective, system for measuring the water flow rate on weir openings, normally used in agricultural contexts, is to measure the height of the water at the lip of the weir.

In this regard, tables and formulas are available in the literature for calculating the flowrate as a function of the width of the opening.

The water flow rate can then be calculated by measuring the width of the opening and the height.

With the availability today of instruments for measuring distances, such as sonar and TOF (Time Of Flight) laser devices, which are accurate and reliable, fitting one of these instruments at the weir load to allow it to be measured continuously would be a simple solution in the case of a fixed geometry configuration.

Openings with removable bulkheads, of the type illustrated in FIG. 7, must however be able to allow adjustment of the height of the bulkheads in order to regulate the channel flow/level of water in the channel and therefore the flowrate towards the different fields/branches.

The operation is done by removing or adding planks, usually made of wood, of different sizes until the level that guarantees the required flowrate is reached.

It would therefore be complex and would require all the skill and expertise of an operator to modify the position of the sensor in the various configurations or to take into account the displacements of the planks using corrective coefficients; otherwise there would be a risk of distorting the reading and therefore the information collected. It should be borne in mind that plank movements are performed manually and with the channel operating under flow.

### SUMMARY OF THE INVENTION

The aim of the present invention is to provide an apparatus which allows the flowrate of water to be controlled remotely, in traditional bulkhead-holder openings, without interfering with manual adjustments of said openings, thus enabling effective use in a rural setting.

Within this aim, an object of the invention is to provide a constructively simple, reliable and sturdy apparatus.

Another object of the invention is to provide an apparatus which does not require greater skill and capability from an operator than are required for traditional adjustment of bulkheads and which allows the flowrate of water through an opening to be measured in a precise and continuous manner.

A further object of the present invention is to provide a structure which, due to its particular constructional characteristics, is capable of ensuring the most extensive guarantees of reliability and safety in use.

This and other objects, which will be better illustrated below, are achieved by an apparatus for the continuous remote measurement of the flowrate of water in irrigation bulkhead-holder openings, characterised in that it comprises a measuring instrument installed at a distance relative to a lower crossbeam that acts as a bulkhead in an opening of an irrigation channel; said apparatus comprising vertical uprights integral with said lower crossbeam and a transmitter device; said apparatus being installable at an opening of an irrigation channel in such a way that said vertical uprights can be made to slide inside bulkhead-holder grooves provided on the sides of said opening; said apparatus enabling the detection of data, including at least the level of the surface of the water at said opening, and the transmission of said data to a remote location.

### BRIEF DESCRIPTION OF THE DRAWINGS

Further characteristics and advantages of the present invention will be more apparent from an examination of the description of a preferred, but not exclusive, embodiment of the invention, illustrated by way of non-limitative example in the appended drawings, in which:

FIG. 1 is a perspective view of the apparatus according to the invention;

FIG. 2 is a side view of the apparatus;

FIG. 3 is a front elevation view of the apparatus;

FIG. 4 is a side schematic view, partially sectioned, which illustrates the apparatus in use;

FIG. 5 is a perspective view of the apparatus illustrated in use;

FIG. 6 is another perspective view of the apparatus illustrated in use;

FIG. 7 is a perspective view of an opening with traditional removable bulkheads.

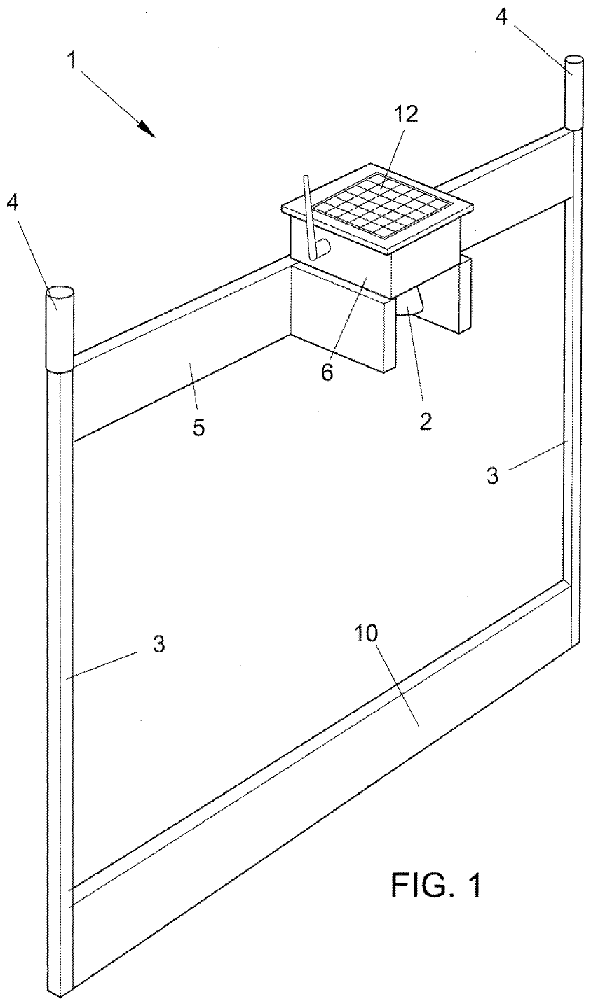

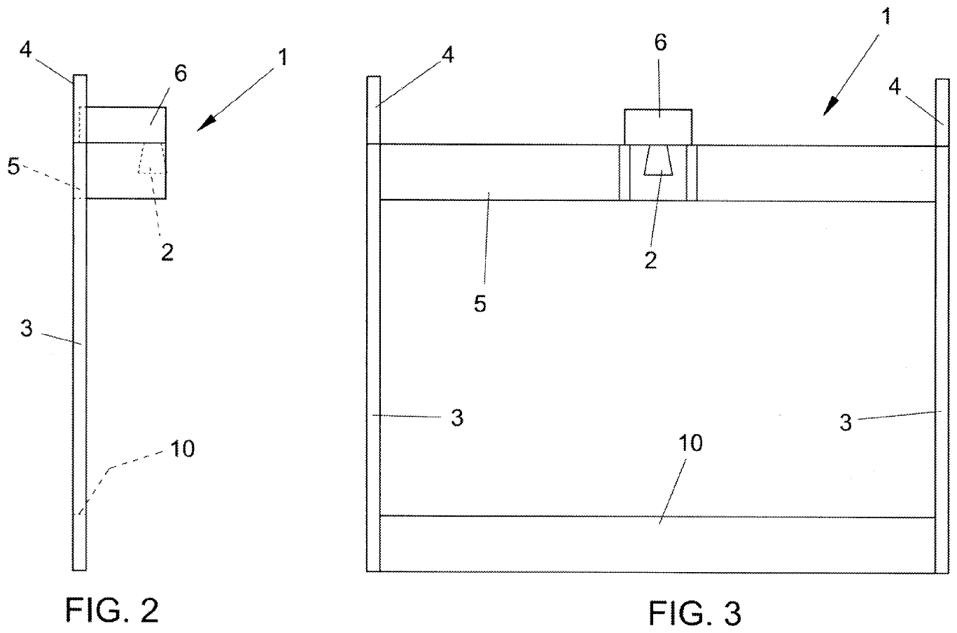

### DESCRIPTION OF THE PREFERRED EMBODIMENTS

With particular reference to the numerical symbols of the aforementioned figures, the apparatus for the continuous remote measurement of the flowrate of water in bulkhead-holder openings for irrigation, according to the invention, indicated as a whole with the reference number 1, comprises a measuring instrument 2 installed at a fixed distance relative to a tooth of a crossbeam 10 which acts as a bulkhead.

The apparatus comprises two vertical uprights 3 integral with the crossbeam 10 and designed to support a connecting crossbeam 5.

The measuring instrument 2 is a distance measuring instrument, such as a sonar, laser or other.

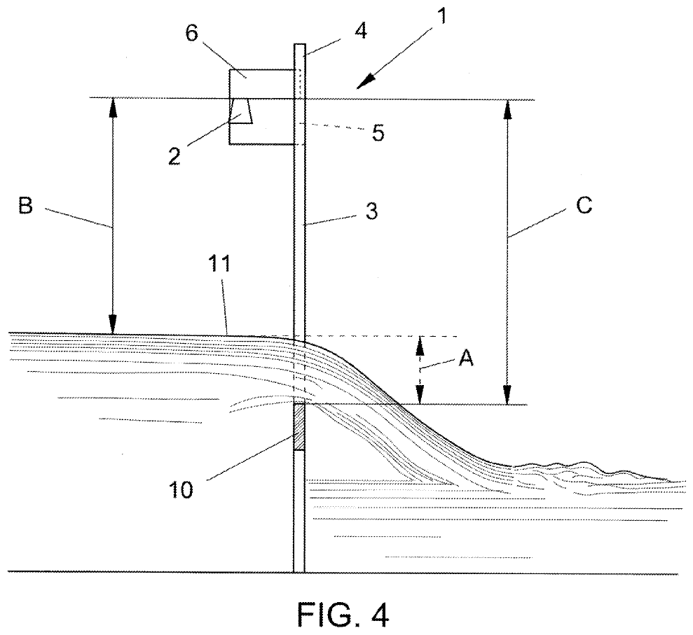

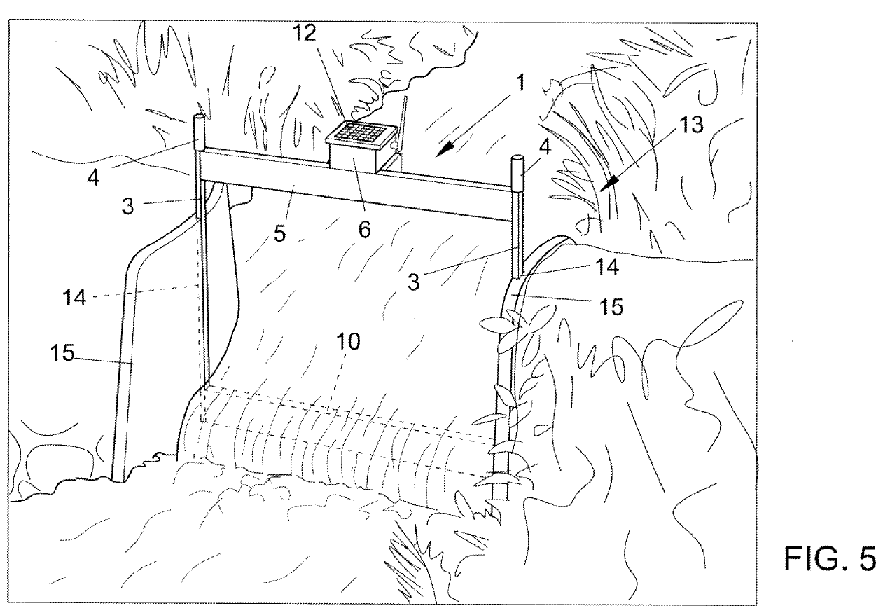

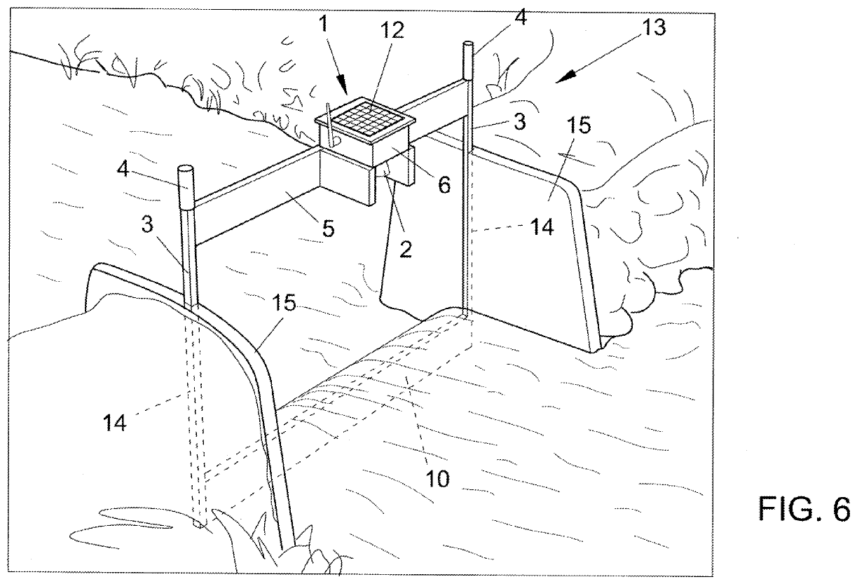

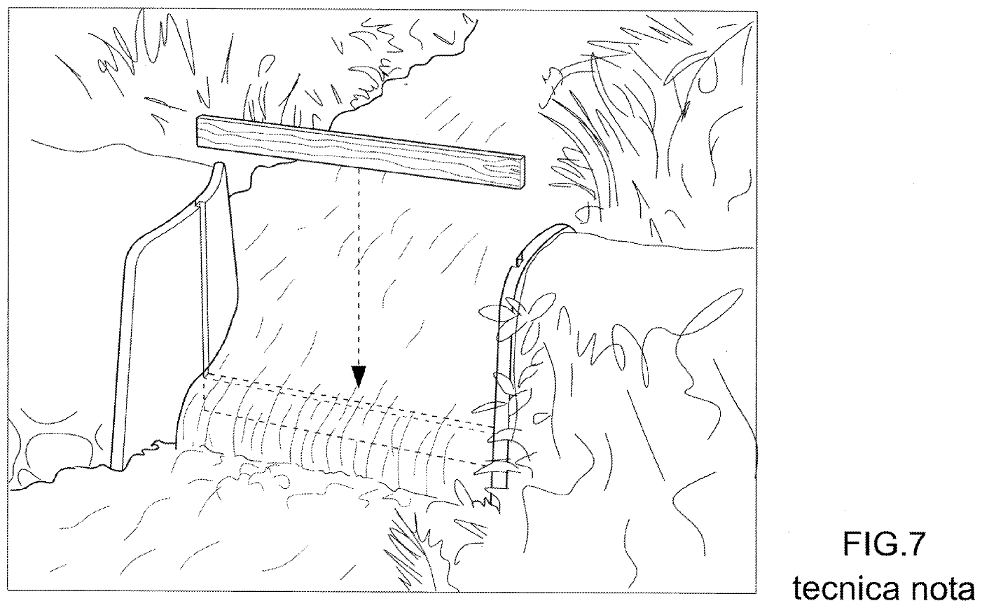

Advantageously, the distance measuring instrument 2 is positioned approximately on the center line of the connecting crossbeam 5 and is moved towards the source area of the water flow 11, so as to detect the height of the weir before the flow narrows, as shown in FIG. 4.

The apparatus further comprises a transmitter device 6, housed inside a watertight container which houses power supply means, such as a battery.

A solar panel 12 is advantageously positioned above the watertight container.

The apparatus may further include projections 4 arranged on top of the uprights 3 and having the function of handles or grips to facilitate handling of the apparatus.

According to a further aspect of the invention, one of the two handles can comprise a mechanism for locking the apparatus. The mechanism includes a pin which, when the handle is rotated, projects at the lower crossbeam and to which a padlock can be applied to lock the handle itself, preventing any unauthorized manipulations.

The apparatus according to the invention is designed to be installed at an opening 13 of an irrigation channel so that the vertical uprights 3 can be made to slide inside the bulkhead-holder grooves 14, provided on the sides 15 of the opening, so as not to reduce the useful width for the water passing through the opening.

With particular reference to FIG. 4, the apparatus of the present invention allows the useful distance A to be measured when distance C, i.e. the distance between the zero reference point of the measuring instrument 2 and the tooth of the crossbeam 10 acting as a bulkhead, which is a fixed and therefore known distance, and distance B, read by the measuring instrument 2 of the surface of the water 11 before it narrows, are known.

Measurement A, sufficient to define the opening port, will therefore be equal to: A=C−B.

If the useful distance A is negative, it means that the channel is not sufficiently flooded, i.e. there is not enough water for the opening to deliver water.

The measurement data are sent via the transmitter device 6 which can consist of a telephone module for data transmission, which will then transmit the measurements collected directly via Internet to a database, to make them directly available for consultation in graphical format for analysis and archiving.

The transmitter can also consist of a radio transmission module completed by a receiver, and if necessary provided with other nodes with the function of repeaters, for routing the data to local or remote databases, for example on local PCs and/or in the “cloud”, consultable through a PC or smartphone.

Alarms can be implemented on the basis of threshold values that can be freely set by the user, so that the latter may be promptly informed when particular conditions arise.

Several apparatus, suitably employed in inlet and outlet openings, allow local water supply balances to be established, where it can be of interest to examine how much water a plain or series of irrigated plains absorb, or to evaluate the flow of water dispersed by a stretch of ducts.

The apparatus may be equipped with additional sensors to measure other parameters that may be considered of interest, for example: water or air temperature, humidity, precipitations, irradiation or movement, the latter being useful for detecting repositioning of the object and therefore transmitting a signal that may be interpreted as a theft/tampering alarm where it is certain that no movement was planned.

As an alternative to contact-less sensors, such as sonars and lasers, contact sensors which directly detect the level of the liquid can be used, by positioning them at the uprights 3 embedded in the bulkhead guides.

It has been found in practice that the invention accomplishes the intended aim and objects.

An advantage of the present invention is first of all the simplicity and robustness of the assembly.

The apparatus has no moving parts and therefore is not subject to wear.

A further advantage is the fact that the present apparatus perfectly conforms to the existing standard for openings with manual bulkheads and it is sufficient to provide implementations with a width equal to the planks present in the opening in order to allow it to be used on different models.

The apparatus of the present invention can also be operated by personnel not qualified in the use of measuring instruments, since, when the instrument is positioned correctly, at the same level as a bulkhead, it is capable of providing reliable measurements.

The apparatus offers the advantage of being based on a very reliable physical principle of flow rate measurement, consisting of the height of the free surface of the head on openings, i.e. the load on the weir.

The apparatus according to the present invention allows a farm to reduce its displacements for water control purposes.

A further advantage is the fact that this apparatus allows exceptional situations to be dealt with quickly which, if they were detected late, would lead to damage or at the least more expensive and less effective repairs, with the risk of damage to crops.

The present apparatus allows water flow rates to be kept under control even in periods in which no checks would normally be made, at nighttime for example.

The present apparatus also allows to keep under control water flow rates into and out of irrigated plains, or systems of channels, even in locations far away from the farmhouses, thus providing increased awareness of water consumption and therefore allowing better planning of corrective interventions and operating methods.

All of the aforementioned advantages are obtained without any need for investment to modify existing openings.

Naturally the materials used, as well as the dimensions, can be any, according to requirements.

1. Apparatus for the continuous remote measurement of the flowrate of water in a bulkhead-holder opening in an irrigation channel, said opening (13) including bulkhead-holder grooves (14) provided on sides (15) of said opening (13); said apparatus being characterised in that it comprises a measuring instrument (2) installed at a distance relative to a lower crossbeam (10) that acts as a bulkhead in said opening (13); said apparatus comprising vertical uprights (3) integral with said lower crossbeam (10) and a transmitter device (6); said apparatus being installed in said opening (13) in such a way that said vertical uprights (3) can be made to slide inside said bulkhead-holder grooves (14); said apparatus enabling the detection of data, including at least the level of the surface of the water (11) at said opening, and the transmission of said data to a remote location.

2. Apparatus, according to claim 1, characterised in that said uprights (3) are designed to support a connecting crossbeam (5).

3. Apparatus, according to claim 2, characterised in that said measuring instrument (2) is a distance measuring instrument such as a sonar, laser or similar.

4. Apparatus, according to claim 3, characterised in that said measuring instrument (2) is positioned on the center line of said connecting crossbeam (5) and is moved towards the source area of the water flow (11), so as to detect the height of the weir before the flow narrows.

5. Apparatus, according to claim 1, characterised in that said transmitter device (6) is housed inside a watertight container which houses power supply means, such as a battery.

6. Apparatus, according to claim 5, characterised in that it comprises a solar panel (12) positioned above said watertight container.

7. Apparatus, according to claim 1, characterised in that it comprises projections (4) arranged on top of said uprights (3) and having the function of handles or grips to facilitate handling of the apparatus.

8. Apparatus, according to claim 1, characterised in that said transmitter device (6) comprises a telephone module for the transmission of data, which transmits the measurements collected directly via Internet to a database, thereby making the data directly available for consultation in graphical format for analysis and archiving.

9. Apparatus, according to claim 1, characterised in that said transmitter device (6) comprises a radio transmission module completed by a receiver, and if necessary provided with other nodes with the function of repeaters, for routing the data towards local or remote databases, for example on local PCs and/or in the cloud, consultable through a PC or smartphone.

10. Apparatus, according to claim 1, characterised in that it comprises further sensors for measuring various parameters, such as water and/or air temperature, humidity, precipitations, irradiation or movement.
